(19) United States
(12) Patent Application Publication
(10) Pub. No.: US 2025/0388000 A1
(43) Pub. Date: Dec. 25, 2025

(54) MULTILAYER BAND AND METHOD FOR PROTECTING A PAINTED PRODUCT

(71) Applicant: Neenah, Inc., Alpharetta, GA (US)

(72) Inventors: Marie DELAGARDE, Valence (FR); Benoit MESNIL, Valence (FR)

(21) Appl. No.: 19/247,695

(22) Filed: Jun. 24, 2025

(30) Foreign Application Priority Data
Jun. 25, 2024 (EP) 24306023.3

(51) Int. Cl. B32B 7/12; B32B 5/02; B32B 27/08

(52) U.S. Cl. CPC B32B 7/12; B32B 5/022; B32B 27/08; B32B 2250/02; B32B 2255/02; B32B 2307/718; B32B 2307/72; B32B 2307/7375; B32B 2307/7376; B32B 2605/08

(57) ABSTRACT

Multilayer bands for protecting a painted product are provided. A multilayer band comprises a protecting layer made of a felt comprising polymer fibers and an adhesive layer comprising an adhesive and covering at least a portion of a surface of the protecting layer. The polymer may comprise recycled PET and the adhesive may comprise polyisobutylene. Methods are also disclosed for applying such a multilayer band on a vehicle body part, such as a door or a bumper.

### CROSS-REFERENCE TO RELATED APPLICATIONS

This application claims the benefit of EP 24306023.3, filed Jun. 25, 2024, the complete disclosure of which is incorporated herein for all purposes.

### TECHNICAL FIELD

This disclosure pertains to the field of devices for protecting painted products.

### BACKGROUND

Various kinds of protections may be provided to a painted product to prevent the paint from being unintentionally scratched or dented. For example, vehicle manufacturers apply a film and/or a foam on specific locations of a newly made vehicle for avoiding any damage to the vehicle during transport, from the factory to the end customer.

One known protecting device consists of a 10 mm-thick polyethylene foam attached to the vehicle body by means of an adhesive tape. It has been observed however that polyethylene foam may fall off the vehicle during transport. Without wishing to be bound by theory, it appears that the foam shrinks especially at concave or curved portions of the vehicle. The shrinkage breaks the cohesion between the foam and the adhesive layer, thereby leading to the foam falling off. Beyond the fact that the fallen foam does not protect the vehicle anymore, fallen pieces of polyethylene foam are damageable to the environment.

To solve this problem, the inventors attempted to use rubber-based adhesive to protect the vehicle. Indeed, the rubber-based adhesive are known to be compatible with the paint of the vehicle. Unfortunately, the inventors noticed that the rubber-based adhesive can be damaged by UV radiations. Indeed, without wishing to be bound by theory, UV seems to degrade the rubber-based adhesive by breaking the molecular cohesion, thereby leading to a peeling issue: it becomes harder to remove the rubber-based adhesive as one piece (when the painted product does not need to be protected anymore), because the rubber-based adhesive breaks apart.

There is therefore still a need for a protecting device which adheres more reliably to a painted product, i.e. one that adheres to the painted product and is properly removable when one wants to remove the protecting device from the painted product.

### SUMMARY

In one aspect, a multilayer band for protecting a painted product is provided. The multilayer band comprises a protecting layer made of a felt comprising polymer fibers, the protecting layer having a density higher than 50 kg/m3; and an adhesive layer comprising an adhesive covering at least a portion of a surface of the protecting layer.

Advantageously, the multilayer band of the present disclosure adheres more reliably to the painted product than the 10 mm-thick polyethylene foam attached to the vehicle body by means of an adhesive tape.

Moreover, the density higher than 50 kg/m3 of the felt enables to filter out the UV radiations, thereby preventing the adhesive layer from being damaged by UV radiations. Additionally, the polymer-fibers felt is not prone to shrinkage and therefore it does not fall off the adhesive layer unintentionally.

The multilayer band is therefore also environmentally friendly as it uses only a controlled amount of material and it does not disperse waste when in use.

The term “protecting” is intended to refer to an ability to prevent damages to the painted product. The protection is mainly intended to be a physical/mechanical protection, i.e. to prevent the painted product from being scratched or dented by another object which would contact the painted product. Although it is not its primary purpose, the multilayer band of the present disclosure may inherently provide a protection of another nature, such as a protection against water, snow, hale, or dust.

A felt is to be understood as an aggregate of fibers forming together a nonwoven soft solid entity. Accordingly, a cotton cloth is not a felt within the meaning of the present disclosure.

The term “about” is intended to mean +/−10% of a given value.

In some examples, the adhesive layer covers only a portion of a surface of the protecting layer.

In some examples the adhesive layer comprises an adhesive top surface with an active portion and a neutralized portion.

In some examples, the adhesive layer has a width (comprised from 10% to 90% of the width of the protecting layer; and/or the active portion of the adhesive top surface has a width comprised from 10% to 90% of the width of the protecting layer.

These various aspects make it possible to adjust the amount of force that is needed to tear the multilayer band off the painted surface independently from the size of the protecting layer, thereby ensuring an appropriate protection against scratches and impacts without simultaneously adding adhesion force between the multilayer band and the painted surface. These designs are also relevant for protecting a moving painted surface which should be free from movement relative to another part, while covering the interstice between said moving part and said another part. The versatility of use of the multilayer band is thereby enhanced. In addition, the adjustment of the amount of adhesive portion of the adhesive layer (either by the size of the adhesive layer relative to the protecting layer or through neutralization) allows to adjust the amount of adhesive material to the conditions of use so that no adhesive material is left on the painted surface after the multilayer band is removed.

In some examples, the density of the protecting layer is from 70 kg/m³ to 400 kg/m³, preferably from 83 kg/m³ to 250 kg/m³, more preferably from 100 kg/m³ to 200 kg/m³. These values ensure that the adhesive layer is protected from UV light for at least one year, which may be advantageous in the context of the car industry.

The density of the protecting layer can be determined by dividing the basis weight of the protecting layer by the thickness of the protecting layer.

The basis weight is measured according to the standard ISO 9073-1:2023.

The thickness is measured according to the standard ISO 9073-2:1989 using a pressure of 2 kPa.

The skilled person will know how to adapt the thickness and basis weight of the protecting layer so as to reach the target density.

In some examples, the protecting layer may have a thickness of at least 1 mm, a basis weight of at least 100 g/m², or a combination thereof. Advantageously, a 1 mm thick felt has shown to be sufficient to protect a painted product from inadvertent scratches.

In some examples, the basis weight of the protecting layer is at least 150 g/m², preferably at least 350 g/m². This value ensures that the adhesive layer is protected from UV light for at least one year, which may be advantageous in the context of the car industry.

In some examples, the thickness of the protecting layer is less than 5 mm. Beyond that thickness, it may not be convenient to wind the multilayer band on a coil: the coil would have a too big diameter for a given useful length, rendering the handling of the coil cumbersome to the operators.

In some examples, the thickness of the protecting layer is from 1.2 to 3.0 mm, preferably from 2.5 to 2.7 mm or from 1.5 to 2.1 mm or from 1.5 to 2.3 mm. The protection of the painted surface from scratches is achieved with a 1 mm thickness, and is improved when the thickness is more than 1.5 mm. Moreover, a value of about 2.6 mm seems optimal to protect the painted surface from impacts, e.g., when opening a vehicle door to not dent the door of an adjacently parked vehicle.

In some examples, for a basis weight of the protecting layer being equal to 100 g/m², the thickness of said protecting layer is from 0.25 to 2 mm, preferably from 0.4 to 1.5 mm, more preferably 0.5 to 1.2 mm. Advantageously such protecting layer protects efficiently the adhesive from UV light and the painted surface from scratches and shocks.

The inventors noticed that, for a basis weight of the protecting layer being equal to 100 g/m², a thickness of said protecting layer being from 0.5 to 0.7 mm is predominantly adapted to protect the painted surface from shocks and the adhesive layer from UV radiations.

The inventors also noticed that, for a basis weight of the protecting layer being equal to 100 g/m², a thickness of said protecting layer being from 0.8 to 1.2 mm is predominantly adapted to protect the painted surface from scratches and to protect the adhesive layer from UV radiations.

In some examples, the basis weight of the protecting layer is less than 500 g/m². A felt that would be denser could fall off due to its weight; or the felt could become too stiff and not conformable enough to be usable on curved/concave surfaces.

In some examples, the basis weight of the adhesive layer is from 30 to 120 g/m², preferably from 80 to 90 g/m², more preferably about 85 g/m². The adhesive layer may have a thickness of less than 1 mm, preferably less than 100 μm, more preferably from 75 to 90 μm. These ranges of value ensure that the multilayer band adheres efficiently to the painted surface to be protected for at least one year, which may be advantageous in the context of the car industry.

In some examples, the protecting layer has a width that is from 10 mm to 50 mm, preferably from 20 mm to 40 mm, more preferably about 30 mm. In some examples, the protecting layer has a length that is comprised from 20 cm to 300 cm, preferably from 30 cm to 70 cm, more preferably about 60 cm. These dimensions offer a good trade-off, i.e. a sufficient protection without spoiling material.

In some examples, the protecting layer has a basis weight from 150 to 450 g/m² and a thickness from 1 to 3 mm, in particular a basis weight from 380 to 420 g/m² and a thickness from 2.5 to 2.7 mm, or a basis weight from 170 to 230/m² and a thickness from 1.3 to 1.7 mm.

In some examples, the polymer fibers comprise fibers of polyethylene terephthalate (PET), fibers of polypropylene (PP), polybutylene terephthalate (PBT), polylactic acid (PLA), viscose, or a combination thereof, preferably fibers of polyethylene terephthalate, fibers of polypropylene or a combination thereof, more preferably fibers of polyethylene terephthalate. The manufacturing or recycling process aimed at obtaining these fibers becomes greener every day. PET presents particularly good results for protecting the adhesive layer from UV light.

In some examples, the polymer fibers comprise at least 5%, preferably at least 10%, more preferably at least 50% of recycled polymer fibers such as recycled PET fibers. Beyond the protection of the environment incurred by the fact that the protecting band does not fall off the painted product, using recycled material further improves the greenhouse gas index of the multilayer band of the present disclosure.

Recycled PET fibers are well adapted be comprised in the felt of the protecting layer of the present disclosure. In particular, the recycled PET may contain impurities which render the felt darker: less material is thus needed to obtain a given UV protection.

The adhesive of the adhesive layer can be any kind of adhesive which does not damage fresh paint when applied and/or removed from said fresh paint. In some examples, the adhesive can be a rubber-based adhesive, silicone adhesive, acrylic adhesive, or a mixture thereof, in particular polyisobutylene. The polyisobutylene is particularly known for having good behavior when applied to or remove from fresh paint.

In some examples, the surface of the felt is entirely covered by the adhesive layer. Alternatively, at least a third or half of the width of the felt is not covered by the adhesive layer.

In one example, the protecting layer has a thickness of from 1.5 to 2.1 mm and a basis weight of from 180 to 200 g/m² and the adhesive layer comprises polyisobutylene and has a basis weight of from 80 g/m² to 90 g/m².

Advantageously, a multilayer band comprising such protecting layer and such adhesive layer efficiently adheres to a painted surface to be protected, protects efficiently the painted surface from scratches and is removable without damage from the painted surface when the painted surface does not need to be protected anymore.

Indeed, the protection layer protects efficiently the painted surface from scratches and the polyisobutylene of the adhesive layer from the UV radiation so that the multilayer band can be removable without damage from the painted surface. The adhesive layer enables the multilayer band to adhere to the painted surface.

A multilayer band comprising such protecting layer and such adhesive layer is suitable for the protection of a vehicle bumper.

In one example, the protecting layer has a thickness of from 2.5 to 2.9 mm and a basis weight of from 350 to 450 g/m² and the adhesive layer comprises polyisobutylene and has a basis weight of from 80 g/m² to 90 g/m².

Advantageously, a multilayer band comprising such protecting layer and such adhesive layer efficiently adheres to a painted surface to be protected, protects efficiently the painted surface from shocks and is removable without damage from the painted surface when the painted surface does not need to be protected anymore.

Indeed, the protection layer protects efficiently the painted surface from shocks and the polyisobutylene of the adhesive layer from the UV radiation so that the multilayer band can be removable without damage from the painted surface. The adhesive layer enables the multilayer band to adhere to the painted surface.

A multilayer band comprising such protecting layer and such adhesive layer is suitable for the protection of a vehicle door.

This description also relates to a method for protecting a painted product, the method comprising: providing a multilayer band according to one of the examples given above; and applying the multilayer band on the painted product, such that the adhesive layer directly contacts the painted product.

In some examples, providing the multilayer band comprises providing the multilayer band as a coil, wherein the adhesive layer is covered by a protective film, the method further comprising unwinding the coil and removing the protective film before applying the multilayer band on the painted product. The protective film may be made of paper.

In some examples, the painted product is a vehicle door having an edge, wherein applying the multilayer band on the painted product comprises applying the multilayer band such that the adhesive layer contacts a portion of the vehicle door adjacent to the edge.

In the method, the multilayer band comprises a protecting layer having a thickness of from 2.5 to 2.9 mm, a basis weight of from 350 to 450 g/m² or a combination thereof, and an adhesive layer comprising polyisobutylene, having a basis weight of from 80 g/m² to 90 g/m², or a combination thereof is advantageous to protect a vehicle door.

In some examples, a portion of the surface of the protecting layer that is void of adhesive layer is free of contact with the vehicle door.

In some examples, the portion of the vehicle door adjacent to the edge is concave.

In some examples, the painted product is a vehicle bumper.

In the method, the multilayer band comprising a protecting layer having a thickness of from 1.5 to 2.1 mm and a basis weight of from 180 to 250 g/m², and an adhesive layer comprising polyisobutylene and having a basis weight of from 80 g/m² to 90 g/m² is advantageous to protect a vehicle bumper.

In some examples, applying the multilayer band on the painted product comprises applying the multilayer band at a corner of the bumper.

### BRIEF DESCRIPTION OF DRAWINGS

Other features, details and advantages will be shown in the following detailed description and on the figures, on which:

FIG. 1 shows a multilayer band.

FIG. 2 illustrates a vehicle door.

FIG. 3 depicts a vehicle bumper.

FIG. 4 shows a multilayer band, winded as a coil.

### DETAILED DESCRIPTION

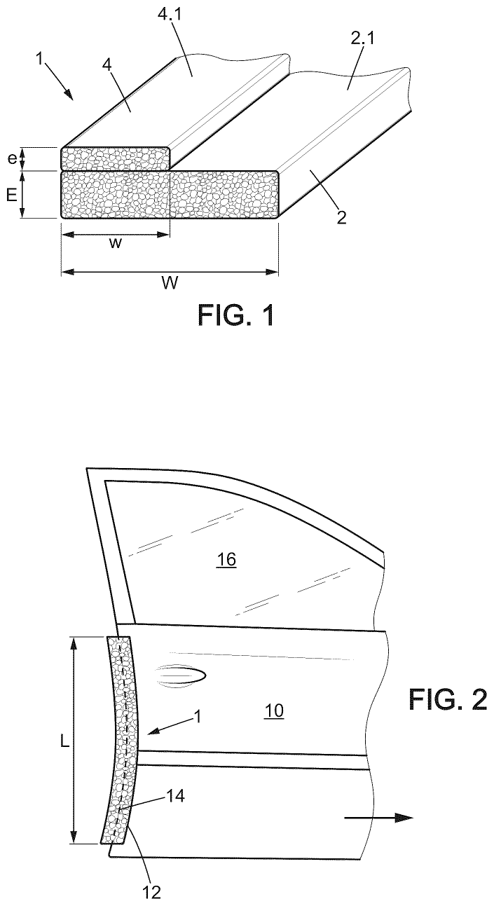

A multilayer band 1 is represented on FIG. 1. The multilayer band 1 is intended to be laid on a painted surface in order to protect it from scratches and/or impacts. The preferred but not limiting application is the car industry, i.e., with the purpose of protecting a car body from the manufacturing plant to the end customer. The multilayer band 1 comprises a protecting layer 2 and an adhesive layer 4. The protecting layer 2 comprises a surface 2.1 and the adhesive layer 4 is directly applied on the surface 2.1 of the protecting layer 2, i.e., there is no intermediate layer between the protecting layer 2 and the adhesive layer. The adhesive layer 4 may be deposited on the protecting layer 2 by a stripe coating process.

The adhesive layer 4 may cover only part of the surface 2.1. In this example, the width w of the adhesive layer 4 is represented to be about half of the width W of the protecting layer. The ratio w/W*100 may be comprised from 10% to 100%, preferably from 10% to 90%, more preferably from 50% to 80%. For example, if the width w of the adhesive layer is of 20 mm and if the width W of the protecting layer is 28 mm, then the ratio is of about 71.4%. The adhesive layer 4 comprises an adhesive top surface 4.1. When the multilayer band 1 is applied on a painted surface, the multilayer band 1 will adhere to the painted surface through the adhesive top surface 4.1, and the multilayer band 1 will be void of adherence with the painted surface where the adhesive layer 4 does not cover the protecting layer 2.

In a variant example (not shown), the adhesive layer 4 is deposited on a bigger portion of the surface 2.1, up to the entirety of the surface 2.1 and part of the adhesive layer may be neutralized, i.e. a portion of the adhesive top surface 4.1 is rendered non adhesive, by covering the portion to be neutralized with a woven or non-woven plastic or paper film. In such a case, when the multilayer band 1 is applied on a painted surface, the multilayer band 1 adheres to the painted surface through an active portion of the adhesive top surface 4.1, and the multilayer band 1 will be void of adherence with the painted surface where the adhesive top surface 4.1 has been neutralized (and potentially also where the adhesive layer 4 does not cover the protecting layer 2, if such is the case). In an analog manner as described above, the width of the active portion of the adhesive layer 4 over the total width of the multilayer band 1 may be comprised from 10% to 100%, preferably from 10% to 90%, more preferably from 50% to 80%.

In a variant, the adhesive layer covers the entirety of the protecting layer. This option is simpler to manufacture as it does not require to apply stripes of adhesive on the protecting layer. In addition, this design may be easier to apply on complex surfaces when it is not needed to protect part of the painted surface without adhesion.

The width W may be comprised from 10 mm to 50 mm, preferably from 20 mm to 40 mm, more preferably about 30 mm. These dimensions allow to use the multilayer band for most of the applications of the car industry and are a good compromise between using sufficient protection at key locations of the painted product without spoiling material.

The protecting layer 2 is made of a felt of polymer fibers, preferably PET or PP. At least 10%, 20%, or 50% of the fibers may be recycled fibers, e.g., recycled PET. These recycled fibers are objectively recognizable for their distinct properties vs. virgin PET/PP, i.e., opacity, number of impurities, density, among others.

The adhesive layer 4 is made of polyisobutylene, which may be advantageous for its adherence force, its flexibility, and its resistance to moisture. The adhesive layer 4 may have a thickness e of less than 1 mm, preferably less than 100 μm, more preferably from 75 to 90 μm.

The protecting layer 2 has a thickness E which is of at least 1 mm, so that the painted product is protected from scratches. Also, this thickness enables the adhesive layer to be protected from UV light. The thickness is preferably less than 5 mm. Indeed, a thicker layer would add weight to the band and would be cumbersome to use as a coil. In some preferred examples, the thickness E is comprised from 2.5 to 2.9 mm, as a good trade-off for protecting from scratches and impacts without the drawbacks that have thicker layers.

The felt of polymer material has a basis weight of at least 100 g/m², preferably at least 150 g/m². This enables to protect the adhesive layer from UV light. In a preferred embodiment, the basis weight is of at least 350 g/m² and optionally less than 500 g/m². When the basis weight of fibers is high, the thickness of the felt can be reduced without compromising the resistance to scratches/impacts or the protection of the adhesive against UV light. However, a too dense felt may be too stiff and may not adhere properly to some curved portions of the vehicle.

It is particularly advantageous when the ratio of the thickness over the basis weight is comprised in a given range. Hence, per 100 g/m² of basis weight, the thickness should be comprised between 0.25 and 2 mm.

FIG. 2 shows a possible application for the multilayer band 1 discussed in relation to FIG. 1. A vehicle door 10 comprises a region 12 adjacent to an edge 14. In this example, the arrow points to the front part of the vehicle and the door 10 may be a driver or a passenger door. A window 16 is also partially shown. The door 10 may be entirely or at least partially concave.

A multilayer band 1 is applied to the region 12. The adhesive layer is in direct contact with the region 12. The edge 14 is mostly hidden behind the multilayer band 1. A portion of the multilayer band 1 that is void of adhesive is cantilevered and may overlap the B pillar without adhering thereto.

FIG. 2 also labels the length L of the multilayer band. The length L may be comprised from 20 cm to 300 cm, preferably from 30 cm to 70 cm, more preferably about 60 cm. These dimensions allow to use the multilayer band for most of the applications of the car industry and are a good compromise between using sufficient protection at key locations of the painted product without spoiling material.

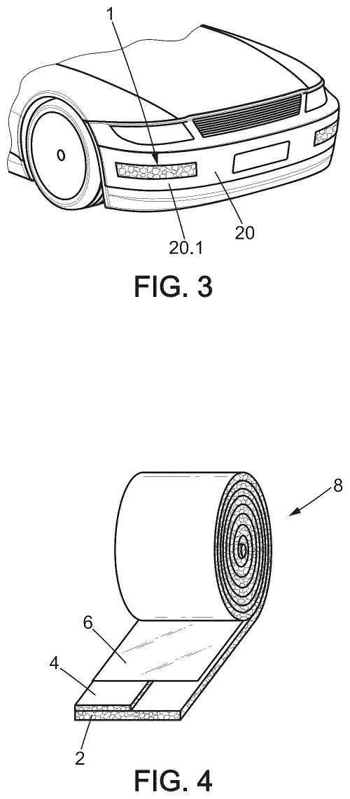

FIG. 3 shows another application, where a multilayer band 1 as discussed above is applied on a corner 20.1 of a bumper 20.

FIG. 4 shows that the multilayer band of the present disclosure can be winded as a coil 8. To that end, a protective film 6 can cover the adhesive layer 4 opposite the protecting layer 2.

A method for protecting a painted product comprises applying a provided multilayer band as discussed above to a painted product, by directly contacting the adhesive layer to the surface of the painted product.

The method may comprise providing the multilayer band as a coil as described in relation to FIG. 4. The coil is therefore unwound and, if necessary, a segment of the multilayer band is cut to a desired length. The protective film 6 is then removed before applying the multilayer band to the painted product.

In relation to FIG. 2 or 3, the method can comprise applying the multilayer band on a region of a vehicle door adjacent an edge, or on a corner of a bumper.

It is important to note that FIGS. 2 and 3 are merely key examples of the use of the multilayer band and other use can be made of the multilayer band of the present disclosure, for example in civil engineering, naval engineering, aerospace industry or domestic use. Although the disclosure focuses on painted products, the body on which the multilayer band is applied may not be painted.

### EXAMPLES

The ability for various felts to protect the adhesive from UV light has been tested. Three samples of felt were tested. Felt 1 is a conventional felt while felt 2 and 3 are manufactured according to the description provided herein. An adhesive made from polyisobutylene is coated directly on the felt by a technique considered as equivalent to reverse roll, i.e. coating the adhesive on a siliconized liner and then laminating the humid adhesive by application of low pressure on the felt.

Each sample of felt is adhered on a surface and then exposed to artificial light in a Q-SUN XE-1 chamber, i.e., a xenon arc chamber which reproduces the damage caused by full-spectrum sunlight. The protocol followed is the standard NF EN ISO 4892-2 (2013), although without addition of moisture. The samples were exposed to a light of the spectrum 300-400 nm at a power of 60 W/m², simulating daylight radiations. The temperature of the black panel was set to 65° C. After 250 hours, 500 hours or 750 hours, a sample of each felt is removed from the surface to assess the presence or not of adhesive residues.

The following table captures the essential results:

TABLE 1
UV protection test

| Basis | Thick- | | Exposure duration | | |
|---|---|---|---|---|---|
| weight | ness | Density | 250 | 500 | 750 |
| (g/m²) | (mm) | (kg/m³) | hours | hours | hours |

| | | | | |
|---|---|---|---|---|
| Felt 1 | 116.5 | 2.5 | 46.6 | Adhesive residues on the surface |
| Felt 2 | 200 | 1.5 | 133.3 | No adhesive residues on the surface |
| Felt 3 | 400 | 2.65 | 150.9 | No adhesive residues on the surface |

The experiments show that irrespective of the time of exposure, felt 1 showed residues of adhesive on the surface. Hence felt 1 failed to protect the adhesive from UV light. In contrast, no residues were found when using felt 2 or felt 3. The protection is therefore not sufficient when density is 46.6 kg/m³ associated with a thickness of 2.5 mm, whilst the protection is sufficient with a density of 133.3 kg/m³ associated with a thickness of 1.5 mm (felt 2) or with a density of 150.9 kg/m³ associated with a thickness of 2.65 mm (felt 3). The comparison between felt 1 and felt 2 shows that a thinner felt with higher density (felt 2) is more adapted to protect the adhesive from UV light than a thicker felt with a lower density (felt 1).

A second experiment has been carried out to assess the resistance to natural UV light of a multilayer band according to the present disclosure (felt 2 above). The samples were positioned on various painted surfaces of car manufacturers (A, B, C and D) and applied with a manual roll applying about 2 kg of force. The samples were exposed to ambient outside light in Valence, France. The samples were analyzed after 1 month (about 750 hours), after 3 months (about 2200 hours) and after 6 months (about 4400 hours). The analysis consists in performing a visual inspection (clean removability, residue, ghosting, swelling, edge residue . . . ) and a peel adhesion measurement according to AFERA 5001.

The table below shows the results.

TABLE 2
evolution of adhesion force with time - UV ambiant light

| | | A | B | C | D |
|---|---|---|---|---|---|
| Adhesion | 1 month | 3.35 | 4.31 | 5.65 | 5.69 |
| on paint | Ext. | | | | |
| plate | 3 months | 3.87 | 4.71 | 5.88 | 5.27 |
| (N/cm) | Ext. | | | | |
| | 6 months | 4.44 | 4.70 | 6.18 | 5.55 |
| | Ext. | | | | |

The results show that the adhesion force does not significantly increase or decrease with time, irrespective of the painted surface on which the multilayer band is applied. We conclude that the adhesive layer has not been degraded over time due to UV light.

Regarding the visual inspection, after the multilayer band has been removed, there is no residue of adhesive material on the painted surface at the location where the adhesive layer adhered to the painted surface. After 6 months, a thin line of residual adhesive appears only on the edges on that location, on all painted surfaces A-D.

In summary, this means that felt number 2 with a thickness of 1.5 mm properly protects the adhesive layer from deterioration due to UV light at least over the period experimented above.

In a third experiment, the artificial ageing has been tested under the standard NF EN ISO 4892-2 (2013) cycle 1. Various samples of felt were adhered on a surface and then exposed to artificial light in a Q-SUN Xe-3 chamber, i.e., a xenon arc chamber which reproduces the damage caused by sunlight. The following parameters were set: E at 340 nm:0.51 W/m²·nm; T° of black sample: 65° C./Air T°: 38° C.; Watering 18′/Drying 102′ (continuous lighting); Relative humidity during drying phase: 50% +/−10%; Total duration: 1000 h.

Three samples were tested. Trial 1 is a multilayer band where the adhesive layer covers the entirety of the felt protecting layer that has a thickness of 1.5 mm. Trial 2 is a multilayer band where the adhesive layer covers the entirety of the felt protecting layer that has a thickness of 2.65 mm. Trial 4 is a reference multilayer band coated with the same formulation (same adhesive) over a black cotton cloth.

The samples were applied on two painted surfaces, a car door paint plate and a bumper. Each sample has a width of 20 mm and is adhered to the painted surface with the assistance of a manual roll applying a force of 2 kg. The analysis consists in performing a visual inspection (clean removability, residue, ghosting, swelling, edge residue . . . ) and a peel adhesion measurement according to AFERA 5001.

A comparative sample is hidden under an aluminum foil so that it is protected from the UV light although it is put under the same temperature conditions as the exposed sample.

On a selected car door paint grade the results are as follows:

TABLE 3
evolution of adhesion force with time - simulated ageing -

| | | | TRIAL 1 | TRIAL 2 | TRIAL 4 |
|---|---|---|---|---|---|
| Adhesion | Initial | | 2.18 | 2.61 | 4.98 |
| on door | 250 h | Exposed | 3.57 | 3.28 | 8.10 |
| paint | | | Only light | Only light | Light edge |
| (N/cm) | | | edge | edge | residue + |
| | | | residue | residue | light cotton |
| | | | | | shrinkage |
| | | Hidden | 3.26 | 3.54 | 7.02 |
| | 500 h | Exposed | 5.00 | 4.19 | 5.64 |
| | White | | Only light | Only light | Light edge |
| | | | edge | edge | residue + |
| | | | residue | residue | light cotton |
| | | | | | shrinkage |
| | | Hidden | 3.99 | 4.20 | 6.86 |
| | 500 h | Exposed | 4.20 | 3.45 | 6.84 |
| | Black | | Only light | Only light | Light edge |
| | | | edge | edge | residue + |
| | | | residue | residue | light cotton |
| | | | | | shrinkage |
| | 750 h | Exposed | 4.23 | 3.96 | 2.28 |
| | | | Only light | Only light | Light edge |
| | | | edge | edge | residue + |
| | | | residue | residue | light cotton |
| | | | | | shrinkage |
| | | Hidden | 3.39 | 4.25 | 6.40 |
| | 1000 h | Exposed | 3.78 | 3.85 | 0.36 |
| | | | Felt | Felt | Adhesive |
| | | | degraded | degraded | transfer/ |
| | | | (more | (more | adhesive |
| | | | dust) and | dust)) and | degradation |
| | | | light | light | (dry) |
| | | | residue | residue | |
| | | | dots | dots | |
| | | Hidden | 3.39 | 3.77 | 6.97 |

The reference sample (Trial 4) shows a high peel adhesion at 250 h but the adhesion decreases progressively until the adhesive is dry and does not provide adhesion force anymore. The sample that is hidden below an aluminum protection and that does not receive UV light maintains a substantially stable adhesive property.

The multilayer bands described herein (Trials 1 and 2) show a moderate peel increase which does not drop after 1000 h exposure. The felt starts to degrade but it is conveniently removable in one piece without tearing it off. At 1000 h, we can observe a few adhesive dots remaining on the painted surface. This shows that the multilayer bands described herein maintain their adhesive property under UV exposition for at least 750 h.

When the painted surface on which the samples are applied is a vehicle bumper, the results are as follows:

TABLE 4
evolution of adhesion force with time - simulated ageing - bumper

| | | | TRIAL 1 | 3367 |
|---|---|---|---|---|
| Adhesion on | Initial | | 1.63 | |
| bumper paint | 250 h | Exposed | 2.78 | 6.36 |
| (N/cm) | | | Only light edge | Light edge |
| | | | residue | residue + light |
| | | | | cotton shrinkage |
| | | Hidden | 1.84 | 3.63 |
| | 500 h | Exposed | 3.86 | 5.43 |
| | | | Only light edge | Light edge |
| | | | residue | residue + light |
| | | | | cotton shrinkage |
| | | Hidden | 2.79 | 5.44 |
| | 750 h | Exposed | 3.86 | 3.13 |
| | | | Only light edge | Adhesive residue |
| | | | residue | |
| | | Hidden | 2.85 | 6.70 |
| | 1000 h | Exposed | 4.12 | 0.30 |
| | | | Felt degraded | Adhesive transfer/ |
| | | | (more dust) and | adhesive |
| | | | light residue | degradation (dry) |
| | | | dots | |
| | | Hidden | 1.88 | 4.99 |

Similarly to the car door paint tests, the reference sample shows a high peel adhesion at 250 h that decreases progressively until it dries.

In contrast, the multilayer bands of the present disclosure show stable peel adhesion and no residue. This shows that the multilayer bands described herein maintain their adhesive property under UV exposition for at least 750 h.

In a further experiment, the short-term evolution of the adhesion was tested under application of a cycle of hot and cold temperatures under AFERA 5001. A cycle lasts for a week. Four similar cycles were run for a total duration of four weeks. For each cycle, the samples were put at 90° C. for 3 days, after which four repetitions of a same 24 h subcycle were performed, each subcycle comprising 4 hours at 80° C. followed by 4 hours at −30° C. followed by 16 hours at 35° C. and 99% of relative humidity.

The results are summarized in the following table:

TABLE 5
evolution of adhesion force through temperature cycles

| | TRIAL 1 | | | | |
|---|---|---|---|---|---|
| | A | B | C | D | Bumper |
| Adhesion paint plate | 1.46 | 1.5 | 2.19 | 2.09 | 1.62 |
| initial (N/cm) | | | Ghosting | | Ghosting |
| Adhesion paint plate | 3.06 | 2.54 | 3.45 | 3.35 | 2.59 |
| after cycle (N/cm) | | | Ghosting | | Ghosting |

TRIAL 2

| | A | B | C | D |
|---|---|---|---|---|
| Adhesion paint plate | 1.57 | 1.63 | 2.37 | 2.3 |
| initial (N/cm) | | | Ghosting | |
| Adhesion paint plate | 2.67 | 2.5 | 3.28 | 3.33 |
| after cycle (N/cm) | | | Ghosting | |

For all samples, we do not observe any swelling (light deformation of the paint). A visible ghosting (optical light mark on the plate with no adhesive residue) is observed which can be easily removed by cleaning with a dry cotton wipe.

The overall conclusion that can be drawn from testing the samples is that a felt having a density higher than 50 kg/m³ enables to prevent any degradation of adhesive on the painted surfaces. The multilayer band described herein is thus particularly adapted for covering vehicle body or bumper of newly produced vehicle which may be handled in various conditions during several months before being delivered to the final customer.

### REFERENCE SIGNS LIST

1: multilayer band
2: protecting layer-felt of polymer fibers
2.1: surface of the protecting layer 2
4: adhesive layer
4.1: adhesive top surface of the adhesive layer 4
6: protective film of paper
8: coil
10: vehicle door
12: region of the vehicle door adjacent to an edge 14
14: edge of the vehicle door
16: window of the vehicle
20: vehicle bumper
20.1: corner of the vehicle bumper
E, e: thickness of the protecting layer and adhesive layer
W, w: width of the protecting layer and adhesive layer
L: length of the protecting layer

1. A multilayer band for protecting a painted product, the multilayer band comprising:
a protecting layer made of a felt comprising polymer fibers, the protecting layer having a density higher than 50 kg/m³; and
an adhesive layer comprising an adhesive covering at least a portion of a surface of the protecting layer.

2. The multilayer band according to claim 1, wherein the adhesive layer comprises an adhesive top surface with an active portion and a neutralized portion.

3. The multilayer band according to claim 1, wherein the adhesive layer has a width comprised from 10% to 90% of the width of the protecting layer.

4. The multilayer band according to claim 1, wherein the active portion of the adhesive top surface has a width comprised from 10% to 90% of the width of the protecting layer.

5. The multilayer band according to claim 1, wherein the protecting layer has a thickness of at least 1 mm.

6. The multilayer band according to claim 1, wherein the protecting layer has a basis weight of at least 100 g/m².

7. The multilayer band according to claim 1, wherein the polymer fibers comprise fibers selected from the group consisting of polyethylene terephthalate, fibers of polypropylene, polybutylene terephthalate, polylactic acid, viscose, and a combination thereof.

8. The multilayer band according to claim 1, wherein the polymer fibers comprise at least 5% of recycled polymer fibers.

9. The multilayer band according to claim 1, wherein the adhesive comprises a material selected from the group consisting of a rubber-based adhesive, silicone adhesive, acrylic adhesive, and a mixture thereof.

10. The multilayer band according to claim 1, wherein, for a basis weight of the protecting layer being equal to 100 g/m², the thickness of said protecting layer is from 0.25 to 2 mm.

11. The multilayer band according to claim 1, wherein the basis weight of the protecting layer is less than 500 g/m².

12. The multilayer band according to claim 1, wherein the thickness of the protecting layer is less than 5 mm.

13. The multilayer band according to claim 1, wherein the protecting layer has a width that is from 10 mm to 50 mm.

14. The multilayer band according to claim 1, wherein the protecting layer has a length that is comprised from 20 cm to 300 cm.

15. A method for protecting a painted product, the method comprising:
providing a multilayer band comprising a protecting layer made of a felt comprising polymer fibers, the protecting layer having a density higher than 50 kg/m³ and an adhesive layer comprising an adhesive covering at least a portion of a surface of the protecting layer; and
applying the multilayer band on the painted product such that the adhesive layer directly contacts the painted product.

16. The method according to claim 15, further comprising providing the multilayer band as a coil, wherein the adhesive layer is covered by a protective film, the method further comprising unwinding the coil and removing the protective film before applying the multilayer band on the painted product.

17. The method according to claim 15, wherein the painted product is a vehicle door having an edge, further comprising applying the multilayer band such that the adhesive layer contacts a region of the vehicle door adjacent to the edge, wherein a portion of the surface of the protecting layer that is void of adhesive layer is free of contact with the vehicle door.

18. The method according to claim 15, wherein the painted product is a vehicle bumper.

19. The method according to claim 18, further comprising applying the multilayer band at a corner of the bumper.
